(19) United States
(12) Patent Application Publication
(10) Pub. No.: US 2005/0190708 A1
(43) Pub. Date: Sep. 1, 2005

(54) Proxy guardian agent

(76) Inventors: Donald B. Farr, O'Fallon, MO (US); Thomas G. King, O'Fallon, MO (US); Joel J. Maleport, O'Fallon, MO (US)

Correspondence Address: THOMPSON COBURN, LLP, ONE US BANK PLAZA, SUITE 3500, ST LOUIS, MO, 63101, US

(21) Appl. No.: 10/788,616

(22) Filed: Feb. 27, 2004

(51) Int. Cl. H04L 12/66

(52) U.S. Cl. 370/294; 370/401; 370/466

(57) ABSTRACT

Methods and apparatus for publishing and subscribing information between entities on heterogenous networks. In a preferred embodiment an agent is provided that includes an interface for an entity that resides on the LAN and an interface to a WAN with a publisher/subscriber architecture. The WAN interface includes publisher and subscriber services for the entity on the LAN. Additionally, the agent may include a translator to translate between the protocols used by the platforms and systems on the LAN and WAN. Moreover, the translator may use XML to accomplish translations. Furthermore, the LAN protocol may be TDM and the WAN protocol may be an Internet protocol.

### FIELD OF THE INVENTION

This invention relates generally to networks, and more particularly, to the interface between Wide Area Networks (WANs) that incorporate Local Area Networks (LANs) that comprise heterogenous communication protocols.

### BACKGROUND OF THE INVENTION

A need exists to enable the exchange of information between users on a variety of existing, independent communications networks. Because these systems are frequently deployed with varying message protocols, users on one system may not be able to receive messages created on the other systems. Additionally, even if a user receives a message from another system, the information contained therein may be lost, corrupted, or obfuscated because of the difference between protocols.

Increasingly, the sharing of information empowers an organization to operate more efficiently and with greater impact. Commercial activities have clearly benefited from the ability to share information from disparate locations. For instance, consumers may now access the Internet, shop among several competitors, choose the best product, and place an order in one sitting. Widespread use of the Hypertext Markup (HTML) data display language enables such powerful convenience.

However, many heritage systems employ proprietary, non-standard, message protocols that are not in ubiquitous use. For instance, the armed forces of the United States employ a variety of legacy systems employing protocols that may be incompatible, to some degree, with each other.

Because of incompatibility between the protocols a user on one network and a user on another network (e.g. a pilot of an aircraft operating on an air command link and a tank commander operating on a battalion link) cannot exchange certain types of electronic messages. Thus, without the information available from the other user, each user suffers from decreased situational awareness. In combat, the results may include an increase in casualties, loss of a mission objective, or merely a delay in accomplishing an objective. In business, the resulting confusion may cause lost sales, increased costs, and lost expansion opportunities. Thus, a need exists to enable the exchange of messages, or sets of messages, between systems using incompatible messaging protocols.

Moreover, many telecommunications systems were optimized to rapidly exchange large amounts of information quickly. Accordingly, many of these systems chose suitable technologies such as Time Division Multiplexing (TDM) to ensure the efficient use of the available (and usually constrained) bandwidth. Thus, the system design focuses on efficiency rather than interoperability.

However, in recent years interoperability has grown in importance. As large corporations merge business systems must be seamlessly melded together to allow the efficiencies sought during the mergers. Likewise, because of the increased need for homeland security, many government entities now desire interoperability among communications systems that were also designed in isolation from each other. For instance, it is now desirable for the telecommunications systems of the armed forces to operate with their civilian counterparts utilized by various emergency response organizations (e.g. police, fire departments, hospitals, and federal, state, and local investigators etc.). Accordingly, another need exists to provide interoperability between disparate systems.

Additionally, the retrofitting of such systems may be quite expensive. For example, the networks, the servers, and the various pieces of telecommunication equipment thereon may require new hardware or software to operate properly. More importantly, if the systems require certification (e.g. by the F.A.A.) then additional expense and delays may be incurred in recertifying the systems.

### SUMMARY OF THE INVENTION

It is in view of the above problems that the present invention was developed. The invention includes methods and apparatus for exchanging information between a plurality of heterogenous networks.

In a first preferred embodiment a method of communicating information between heterogenous systems is provided. The method includes acting as a subscriber on a Wide Area Network (WAN) for a first entity on a proprietary, non Internet Protocol based network. The WAN provides publisher/subscriber services. These services allow the first entity to subscribe to a piece of information and transmit that information to the first entity when received by the WAN (from a known publisher). The method also includes accepting a piece of information from the WAN according to the subscription. Additionally, the method includes transmitting the information to the first entity. In the alternative, the method may include accepting a second piece of information from the first entity and acting as a publisher of the second information for the first entity.

In other preferred embodiments the method may include time division multiplexing information with the first entity and using the Internet Protocol (IP) on the WAN. Moreover, the method may include fusing the first piece of information with a third piece of information and transmitting the fused information even if the first and third pieces of information are transmitted at different rates from various entities on ubiquitous networks.

Additionally, the method may include translating the first piece of information from a protocol associated with the first piece of information and a second protocol associated with the second piece of information. Such translations may be performed using the Extensible Markup Language (XML). Moreover, the method may include validating the second piece of information by comparing the protocol in which the second piece of information arrives with an expected protocol for the second piece of information. If the protocol of the second piece of information and the expected protocol do not match, then the method may include ignoring subsequent pieces of information from the same source. Furthermore, the method may include accepting a request for a changed subscription from the first entity and changing the subscription.

In yet another preferred embodiment, an agent is provided that includes an interface for an entity that resides on a LAN (and other proprietary, non IP based networks) and an interface to a WAN, where the WAN includes a publisher/subscriber architecture. The WAN interface includes publisher and subscriber services for the entity. Additionally, the agent may include a translator to translate between the protocols used on the LAN and WAN. Moreover, the translator may use XML to accomplish translations. Furthermore, the LAN protocol may be TDM and the WAN protocol may be the Internet protocol. In other preferred embodiments, the agent may also include an information fuser that fuses information from more than one source and transmits the fused information to a subscriber regardless of whether the publisher publishes the information at different rates.

In still other preferred embodiments, the agent may include a validation manager. The manager validates information received from the WAN by comparing the protocol used to convey the information with a protocol expected for information from the WAN. If the information fails to use the expected protocol, the validation fails. Accordingly, subsequent information received from the same source may be disregarded. Moreover, the agent may be implemented in hardware, firmware, software, or combinations thereof.

In yet another preferred embodiment, the present invention provides a communications network. The network includes a first LAN having a first protocol and a first entity configured to use the first protocol to communicate over the first LAN. Additionally, the network includes an agent associated with the first LAN and interposed between the first LAN and a WAN. The WAN includes a publisher/subscriber architecture. According to the principals of the present invention. The agent either acts as a publisher or a subscriber of the first entity. If the agent acts as a publisher it publishes information transmitted from the first entity. If the agent acts as a subscriber it receives information for the first entity and transmits that information to the first entity.

In other preferred embodiments, the information to be received for the first entity may be transmitted from a second LAN in communication with the WAN. In the alternative, the second LAN may subscribe for information transmitted by the first entity. Furthermore, the first protocol may be TDM and a second protocol (used by the WAN) may be the Internet protocol. Moreover, the first protocol may be a TADIL-J or VMF protocol. Also, where the first and the second protocols are different, the agent may include an XML based translator to translate between the protocols. In still other preferred embodiments, the LAN may be associated with a mobile platform, such as an aircraft.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 illustrates a wide area network in accordance with a preferred embodiment of the present invention;

FIG. 2 illustrates an agent in accordance with another preferred embodiment of the present invention; and

FIG. 3 illustrates a method in accordance with yet another preferred embodiment of the present invention.

### DETAILED DESCRIPTION OF THE PREFERRED EMBODIMENTS

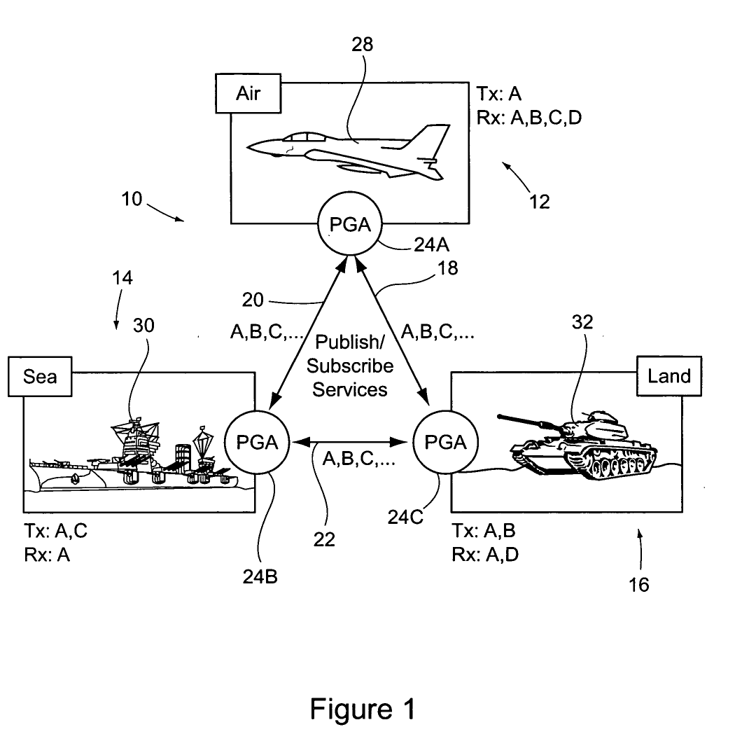

Referring to the accompanying drawings in which like reference numbers indicate like elements, FIG. 1 illustrates a network constructed in accordance with the principals of the present invention. The network 10 includes other networks 12 to 16. In general, the networks 10 to 16 may be any type of telecommunications network, even proprietary, closed, non-IP based networks. However, in a preferred embodiment the first network 10 is a WAN and the other networks 12 to 16 are LANs.

The WAN 10 includes several proprietary local area networks (LANs), or intranets, 12, 14, and 16 that are interconnected via data links 18, 20, and 22. By the term “proprietary,” herein, it is meant that the protocols used on the networks are not generally known. Rather, the network uses a protocol unique to the owner of the network. That is, the protocol may be considered as unique. The LANs 12 to 16 may be weapons platforms including a variety of networked processors, as shown. In the alternative, the LANs 12 to 16 may be any commercial, industrial, or residential network of types well known in the art. The data links 18 to 20, likewise, are well known in the art and include, for example, wireless or fiber optic links providing connectivity between the LANS 12 to 16.

Typically, the LANs 12 to 16 include legacy systems that rely upon differing messaging protocols to exchange information between processors (or nodes) of each, individual LAN. Because the protocols may be incompatible, messages from one LAN (e.g. LAN 12) may not be compatible with the protocol on another LAN (e.g. LAN 14.) Thus, an application 24 may be installed on a computer, or server, on each of the LANs 12 to 16 to accept incoming messages and determine which entities on the LAN 12 are the intended recipients of the first message. Once the application 24 determines the destinations, application 24 may then extract information from the message and insert that information in a new message (in the appropriate format) for the destination and send the new message to the destination.

Thus, the application 24 enables messaging between networks having heterogenous messaging protocols. Of course, a central application 24 may serve all of the LANs 12 to 16 instead of the separate servers 24A to 24C shown in FIG. 1. It should also be noted that the WAN 10 generally includes a publisher/subscriber architecture. Additionally, the agent 24 may reside on the WAN 10 in parallel with pre-existing communication paths to the LANs 12 to 16.

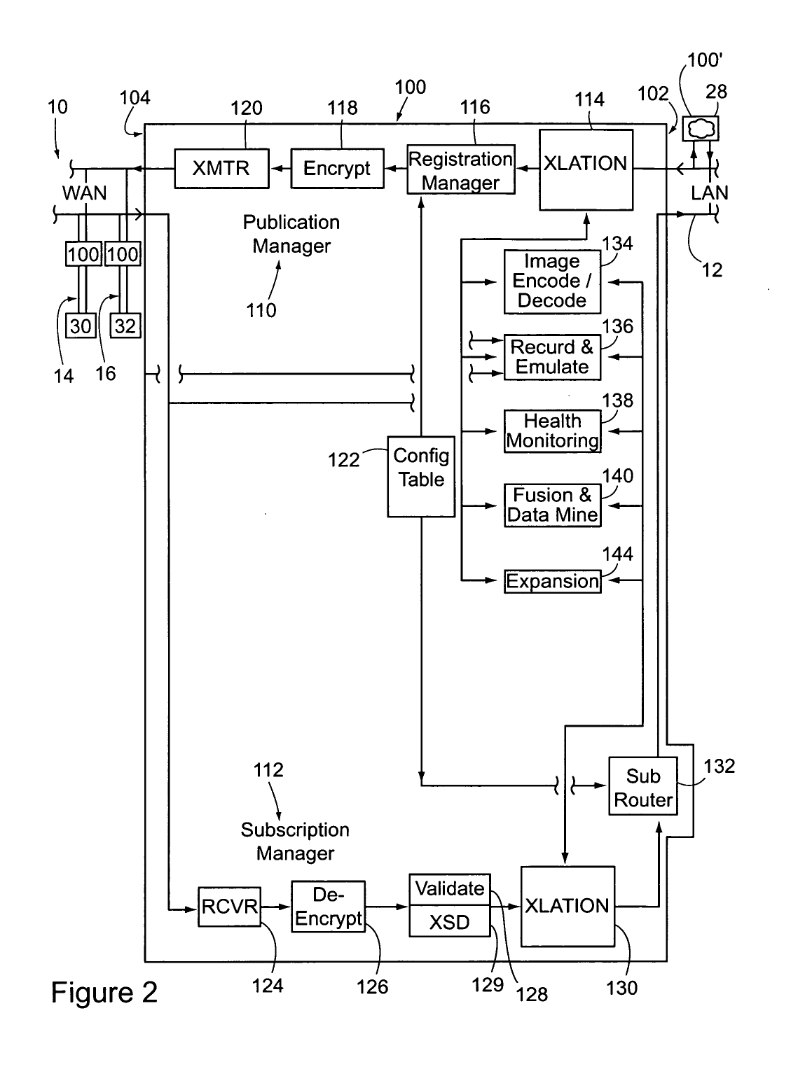

With reference now to FIG. 2, a proxy guardian agent 100 in accordance with a preferred embodiment of the present invention is shown. At a general level, the agent 100 includes a proprietary LAN interface 102 and a WAN interface 104. The LAN interface 102 provides a communication path to one, or more, of the LANS 12 to 16 of FIG. 1. In some instances, the interface 102 includes, or is configured to operate as a TDM transceiver. More particularly, the LAN interface 102 may be a pre-existing component of the LAN 12. Though, the present invention is not limited to TDM LANs. Accordingly, both public and private messages may be communicated between the interface 102 and the entities on the LAN (for example the mobile platform shown as an aircraft 28). By “public messages” it is meant that all entities 28 on the LAN 12 may receive the message whereas “private messages” implies that the receipt is limited to a select subset of the LAN entities 28.

At the WAN interface 104, a communication path between the other LANs (e.g. LAN 14 and 16) may be provided via the WAN 10. Because the WAN 10 (or one of the other LANs 14 or 16) may include a publisher-subscriber architecture, it is often desirable for the entities 28 on the LAN 12 to publish information to the WAN 10. Similarly, it is often desirable to allow the LAN 12 entities to subscribe for information from the WAN 10. However, many LANs 12 to 16 and the entities thereon 28 to 32 are not configured to provide the functionality for publishing information and subscribing thereto.

Thus, in accordance with the principles of the present invention, the agent 100 includes a publication manager 110 and a subscription manager 112. Generally, the publishing manager 110 includes those services involved in accepting a message from an entity 28 and publishing it to other entities. Similarly, the subscription manager 112 generally includes those services involved in accepting a message from a channel on the WAN 10 and forwarding it to the entity 28 that subscribed to the channel.

With previous systems, to publish or subscribe to information via the publisher/subscriber application (on the WAN 10), an entity would first have to register with the publisher/subscriber application. In turn, the publisher/subscriber application configures channels through which a publishing entity publishes information and through which the publisher/subscriber application sends information from the channels to those entities subscribed thereto. As noted, not all entities possess the ability to publish, or subscribe to, information. In particular, many entities 28 are incapable of registering themselves with the publisher/subscriber application.

Thus, in accordance with the principals of the present invention, the agent 100 handles the registration necessary to establish the channels for the entity 28. In one preferred embodiment, the publication manager includes a protocol translator 114, a registration manager 116, an encryption machine 118, and a transmitter 120. Note, that while FIG. 2 illustrates the registration manager 116 as being associated with the publication manager 110, it need not be associated with the publication manager 110. For instance, the registration manager 116 could be considered as being shared between the publication and subscription managers 110 and 112. Though, for reasons that will be discussed shortly, FIG. 2 depicts the registration manager 116 as being associated with the publication manager 110.

In one preferred embodiment, the registration proceeds as follows. First the entity 28 begins transmitting messages over the LAN 12 (for example, upon power up, re-establishing communication over the LAN 12, etc.). As the messages arrive via the LAN 12, the messages reach the registration manager 116. In the current embodiment, the registration manager 116 consults a publication/subscription configuration table 122. From the table 122, the manager 116 automatically determines which pre-selected channels the entity 28 will publish to and subscribe from based on the protocol detected in the incoming message. The registration manager 116 then sends an appropriate registration request (either for publication, subscription, or both services) to the publication/subscription service resident on the WAN 10. If necessary, the request may be encrypted via an encryption machine 118 before being transmitted over the WAN 10 by the transmitter 120. Of course, if the registration entity fails to receive messages from the entity 28 (i.e. the entity 28 times out), pre-existing registration may be terminated by a request sent from the registration manager 116 to the WAN 10 service. Accordingly, the registrations of the present embodiment may be deemed “automatic registrations.”

In an alternative embodiment, the registration request may be made explicitly by the entity 28. In such instances, the entity 28 sends an explicit registration request message over the LAN 12 to the agent 100. The registration manager 116 detects the explicit request message and then initiates a registration as specified in the request message. Then, when it is desired for the corresponding publication and subscription capability to be terminated, the entity 28 sends an explicit termination request message via the LAN 12. Accordingly, the registration manager 116 requests that the corresponding publication and subscription registrations be terminated by the WAN 10 publication/subscription service. Note that the registration manager 116 may update the table 122 according to the explicit requests. Thus, the entity 28 may dynamically modify its registration as desires change.

When the registration with the WAN 100 service is complete, the agent 100 allows the entity 28 to publish and subscribe as follows. For publication, when the entity 28 transmits a message containing information to be published over the LAN, the message reaches the registration manager 116. Whereupon the registration manager 116 examines the content of the message and detects the presence of information that publication thereof is desired (e.g. by comparison with criteria stored in the configuration table 122 or by location within a TDM message time slot). Accordingly, the manager then forwards the message to the WAN 10 for publication via the appropriate WAN 10 channel. Thus, the entity 28 need not be configured, or even capable of, registering to publish information. Nor does the entity 28 need to be capable of publishing information itself. Instead, the agent 100 acts as a proxy for the entity 28 and performs the registration and publication for the entity 28.

In a similar manner, the agent 100 acts as a proxy for the entity 28 to receive information for which the agent 100 registers a subscription for the entity 28. In another preferred embodiment, the agent 100 includes a receiver 124, a decryption machine 126, a validation unit 128, a translator 130, and a subscription router 132.

For instance, when a message arrives over the WAN 10 from the channel, it will be addressed to the agent 100 because the agent 100 registered itself, on behalf of the entity 28, as the subscriber. Accordingly, the receiver 124 receives the message and forwards it to the subscription router 132. The router 132 thereafter consults the publication/subscription table 122 to determine for which entity 28, or entities, on the LAN 12 the message was received. Note that in response to dynamic, or transient, registration requests, it is desirable for the registration manager 116 to update the table 122. Accordingly, the subscription router 132 then routes the message in an appropriate manner. For example, if the LAN 10 employs TDM, then the router inserts the message at an appropriate time slot in the agent's LAN 12 transmission. Accordingly, the entity 28 receives the messages for which it subscribed via the agent 100. Thus, in accordance with the principles of the invention, the entity 28 need not be capable of subscribing to receive information relevant to the desired subscriptions.

Of course, an agent 100′ may reside in the entity 28 or in a node of a LAN. Thus, in the current embodiment, the agent 100′ may serve just the one node 28. Accordingly, the router 132 may not be necessary or may be configured to deliver the message to the subscribing application, thread, program, or instance in the node 28. Nonetheless, the agent 100′ allows the node 28 to utilize the publisher/subscriber services even though the node 28 would otherwise not be capable of publishing and subscribing for information. Otherwise, the router allows the agent 100 to be used in firewall.

Turning now to another preferred embodiment, FIG. 2 also illustrates the agent 100 incorporating a pair of protocol translators 114 and 130. As is known, the LANs 12 to 16 and the WAN 10 may employ different message protocols as illustrated in FIG. 2. By way of example, the WAN 10 could use the Internet Protocol (IP) while the LAN 12 could use the TADIL-J (Tactical Digital Information Link) or VMF (Variable Frequency Format) TDM protocols. Though, because of the extensive number of protocols available (including proprietary protocols), many other combinations are possible and are too extensive to list herein.

The translators 114 and 130 operate to extract information from messages (in one format) and build new messages (in another format) inserting the extracted information therein. Thus, translator 114, for example, converts the TADIL-J (also known as Link 16) message from the LAN 12 to a message in the IP protocol for subsequent transmission over the WAN 10. Translator 130 reverses the process for messages received from the IP WAN 10 for subsequent transmission over the TADIL-J LAN 12.

Another benefit arising from the translators 114 and 130 is the ability to compress messages, in particular XML messages. As is known, XML messages tend to grow rather large (e.g. several kilobytes). Thus, they tend to consume bandwidth on bandwidth-constrained networks. Because the translators are data centric, they can isolate and extract only those pieces of information from a message that the entity 28 needs. Accordingly, the translated message may be several orders of magnitude smaller than the original message sent over the WAN 10 or LAN 12.

The description of a few additional exemplary embodiments will serve to illustrate additional capabilities of the agent 100 according to various preferred embodiments of the present invention. For instance, an imaging encoder/decoder 134 may be included in the agent. The imaging unit 134 can encode images received from the entity 28 for incorporation into XML messages to be created by the translators 114 and 113. Thus, entities 28 may send and receive messages containing images even though, heretofore, the entity 28 was incapable of such actions.

Additionally, a record and emulation unit 136 may be included in the agent 100. As a recorder, the unit 136 saves incoming and outgoing messages, preferentially as binary files. Thus, the recorder 136 may play back the messages and recreate the information flow through the agent 100. Additionally, the emulator 136 may process the incoming and outgoing messages to determine such design parameters as recurrence and dissemination rates. Accordingly, proposed systems incorporating heterogenous networks may be studied with the aid of an agent 100 to determine how to design and enhance the WAN 10. Such an embodiment provides enhanced analysis, design, test, and evaluation capabilities. For instance, if the exchange of messages is largely between two specific entities a direct communications link may be a preferred solution rather than reliance on the network.

In yet another preferred embodiment, the agent 100 may include a health monitor 138. The health monitor 138 may gather data regarding the operating states of the platforms (e.g. the LANS 12 to 16 and the entities 28 to 32). For instance, the monitor 138 may store Built-In-Test (BIT) information embedded in the LAN 12 messages. In turn, the health monitor may publish the information via the registration manager 116 (in a manner similar to that of the entity 28). Thus, for example, the monitor 138 may automatically send the health data to a help desk or maintenance department for analysis and support. Additionally, the monitor may also gather diagnostic data from the agent 100, the host machine, and registered platforms. Accordingly, if the agent 100 is operating in a degraded state, or approaching failure, the monitor 138 may request corrective action. For instance, the health monitor 138 may request that the agent 100 be cloned (along with current state data) so that the services provided by the agent 100 continue without interruption for the host/platform.

Moreover, the agent 100 may include a data fuser or data miner 140. If data fusion is desired the data fuser 140 may accept messages from two or more sources e.g. entities 30 and 32) and incorporate select information from each into a third message. The third message may thereafter be sent to the entity 28 or to other entities in communication with the WAN 10. More particularly, the messages containing the information to be fused may be transmitted at different rates, with the third message perhaps being transmitted at a third rate. Preferably, the third rate may be slower than the other two rates to decrease bandwidth use on the WAN 10 and LANs 12 to 16. For instance a routine message from one entity may be published at 20 Hz, a routine message from another entity may be published at 30 Hz, and the resulting fused message may be broadcast at 5 Hz. Similarly, data mining may be employed to fuse messages and decrease bandwidth use.

Additionally, the agent 100 may include the message validator 128. The validator 128 examines the incoming messages from the WAN 10 and compares the “as received” protocol against the protocol that the validator expects to receive from a particular source. Thus, if the validator 128 detects Link 4A message (e.g. for air control) from a source that should be transmitting with the Link 11 protocol (e.g. for surveillance), the validator 138 may invalidate the message. In the alternative, the validator 138 may also compare the contents of the message to determine whether the source properly compiled the message. For instance, if the message contains a particular field (e.g. time and date stamp) that is blank or corrupted, the validator 138 may invalidate the message to protect the system from a suspect source.

One exemplary validator compares the WAN message against an XML schema definition (XSD) 129 to detect invalid messages. Thus, the validator 128 uses XSD as a security tool. Of course, invalid messages may be disregarded, deleted from the system, or cause a warning or other error message to be generated.

In yet other embodiments, the agent 100 includes a pair of encryption and decryption machines 118 and 126. Thus messages bound for the WAN 10 may be encrypted to preserve secrecy while messages received from the WAN 10 may be decrypted for subsequent use.

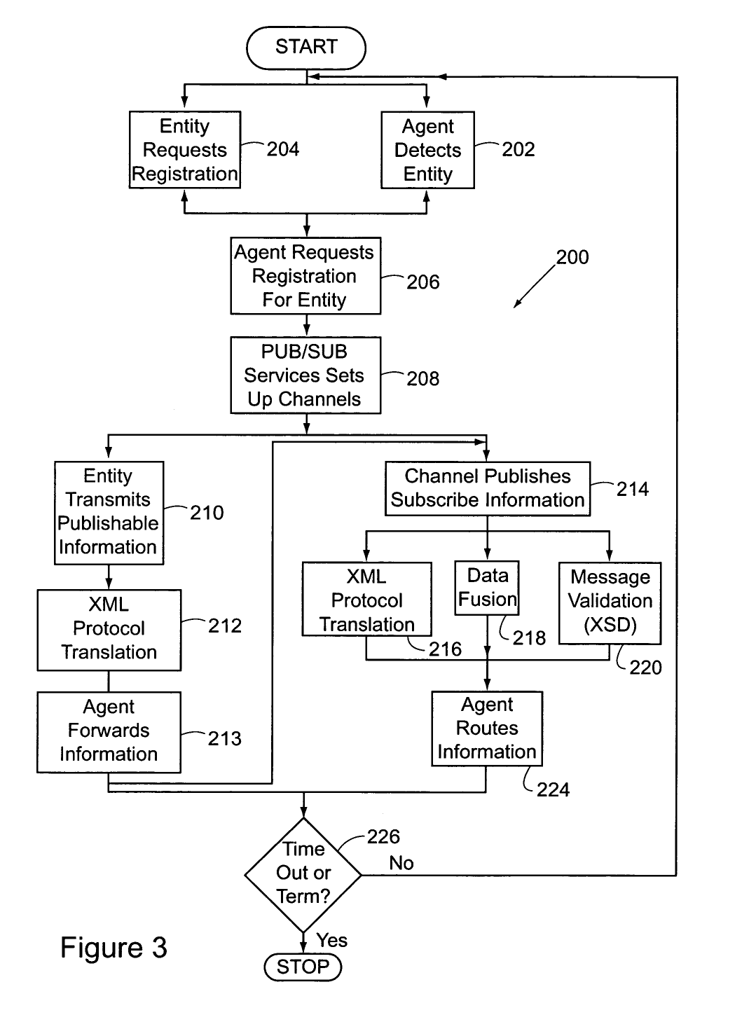

Turning now to FIG. 3, a flowchart depicts a method in accordance with the principals of the present invention. In the method 200, an agent may detect the presence of an unregistered entity via the messages the entity begins to send (upon establishing communication with the agent) at operation 202. In the alternative, an entity may dynamically request registration as in operation 204. The agent (upon detection of the entity or receipt of the request) requests registration from a publisher/subscriber service (See operation 206). To complete the registration, the publisher/subscriber service (of the WAN 10) sets up the channels to which the entity transmits, or from which it will receive, information according to the registration (see operation 208).

Subsequently, if the entity transmits publishable information, as in operation 210, then an XML based translation of the information may be performed at 212. Once translated (if desired), the information may be forwarded by the agent to a channel associated with the WAN. In turn, the publisher/subscriber service publishes the information via the channel to the subscribing entities. If, on the other hand, a channel publishes information to which the entity has subscribed then the agent may receive the information from the channel (see operation 214). Thus, an entity transmitting information regarding weather in Baghdad might publish that information to a channel earmarked for the Iraqi theater via the agent. In turn, the publisher/subscriber services can publish the information to entities subscribing to the Iraqi theater channel.

In other preferred embodiments, the information may be translated (operation 216), the information may be fused with other information (operation 218), or the message may be validated, for example by use of an XSD schema (operation 220). Once the agent has received the information, the agent then routes the information to the subscribing entity at 224. Of course, if the entity dynamically requests that the registration be withdrawn (i.e. terminated), or of the entity times out, then the registration is terminated as requested by the agent. See operation 226. Otherwise, the method 200 may repeat with new or modified registrations and with continued publishing/subscribing activity.

In view of the foregoing, it will be seen that the several advantages of the invention are achieved and attained. In particular, because the agent may reside on the LANs in parallel with pre-existing components, the invention requires no retrofitting or recertification of the existing LANs and platforms. Moreover, despite the minimal impact on the pre-existing LANs the invention provides interoperability between heterogenous systems. Additionally, because any number of entities may publish, or subscribe to, the types of information available in a system, the present invention provides 1 to 1; 1 to many; many to 1; and many to many communications. Yet, if the agent is disconnected from the LAN with which it is associated, the entities thereon may still communicate via the protocol on the LAN (the proprietary network).

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A method of communicating information between heterogenous systems, the method comprising:
at least one of:
acting as a subscriber on a first network including a publisher/subscriber architecture for an entity on a second network, accepting a first information from the first network according to the subscription, and transmitting the first information to the entity, and
accepting a second information from the entity, and acting as a publisher of the second information for the first entity.

2. The method according to claim 1, further comprising time division multiplexing information with the entity.

3. The method according to claim 1, further comprising fusing the first information and a third information and transmitting the fused information.

4. The method according to claim 3, wherein the first and the third informations are transmitted at different rates.

5. The method according to claim 1, further comprising translating the first information from a protocol associated with the first information and a second protocol associated with the second information, the first and the second protocols being different.

6. The method according to claim 5, wherein the first protocol is a TDM protocol and the second protocol is an Internet Protocol.

7. The method according to claim 5, further comprising using XML to translate between the first protocol and the second protocol.

8. The method according to claim 1, further comprising validating the second information by comparing the protocol associated with the second information against an expected protocol for the second information.

9. The method according to claim 8, wherein the validating further comprises using an XSD schema.

10. The method according to claim 8, further comprising ignoring subsequent messages from the same source if the validation failed.

11. The method according to claim 1, further comprising accepting a request for a changed subscription from the entity and changing the subscription, whereby dynamic subscription registration occurs.

12. An agent, to be interposed between a first network and a second network, the agent comprising:
an interface to an entity, the entity interface including a first protocol for communicating with the entity over the first network; and
an interface to a publisher/subscriber architecture on the second network, the publish/subscribe interface to include a service to act as a publisher for the entity and a service to act as a subscriber for the entity.

13. The agent according to claim 12, further comprising a translator to translate between the first protocol and a second protocol associated with the second network, the first and the second protocols being different.

14. The agent according to claim 12, wherein the translator being based on XML.

15. The agent according to claim 12, further comprising an information fuser wherein the fuser to fuse information from at least two sources, the sources being associated with at least one of the first network and the second network.

16. The agent according to claim 15, wherein the fuser being configured to accept information from the first and second sources at different rates.

17. The agent according to claim 12, further comprising, a registration manager to register the first entity as at least one of a publisher and a subscriber.

18. The agent according to claim 12, further comprising, a validation manager to validate information received from the second network.

19. The agent according to claim 18, wherein the validation manager to validate the information by comparing the protocol associated with the information received from the second network with an expected protocol for information received from the second network.

20. The agent according to claim 19, further comprising an XSD schema used by the validation manager to validate the information received from the second network.

21. The agent according to claim 12, wherein the entity interface is a TDM interface.

22. The agent according to claim 12, wherein the second network interface includes an Internet interface.

23. The agent according to claim 12, further comprising being implemented in at least one of hardware, firmware, and software.

24. A communications network, comprising
a first network having a first protocol;
an entity configured to use the first protocol to communicate over the first network; and
an agent associated with the first network interposed between the first network and a second network including a publisher/subscriber architecture, the agent to act as at least one of:
a publisher for the entity for a first information to be transmitted by the entity, and
a subscriber for the entity for a second information to be transmitted to the agent.

25. The network according to claim 24, further comprising:
a third network in communication with the second network and providing the second information.

26. The network according to claim 24, further comprising:
a third network in communication with the second network and subscribing for the first information.

27. The network according to claim 24, wherein the first protocol is a TDM protocol.

28. The network according to claim 27, wherein the first protocol is TADIL-J.

29. The network according to claim 27, wherein the first protocol is VMF.

30. The network according to claim 24, the agent further comprising an translator for translating between the first protocol and a second protocol.

31. The network according to claim 30, wherein the translator is based on XML.

32. The network according to claim 24, wherein the first network is associated with a mobile platform.

33. The network according to claim 32, wherein the mobile platform is an aircraft.

34. The network according to claim 24, the agent further comprising a validation manager to validate information received from the second network by comparing a protocol associated with the information received from the second network with an XSD schema.

35. The network according to claim 24 wherein the first protocol is custom to the first network.
